(19) United States
(12) Patent Application Publication
(10) Pub. No.: US 2008/0304050 A1
(43) Pub. Date: Dec. 11, 2008

(54) STAGE APPARATUS, EXPOSURE APPARATUS, AND DEVICE FABRICATION METHOD

(75) Inventor: Hiroshi Kurosawa, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/134,630

(22) Filed: Jun. 6, 2008

(30) Foreign Application Priority Data
Jun. 11, 2007 (JP) 2007-154434

(51) Int. Cl. G01N 21/00

(52) U.S. Cl. 356/73

(57) ABSTRACT

A stage apparatus comprising a first stage and second stage configured to be able to move between a first area and second area on a stage moving surface of a base, a first mirror and second mirror arranged on the first stage and second stage, respectively, to measure positions of the stages in a first direction parallel to the stage moving surface, and a control unit configured to control to move one of the first stage and the second stage to a position where measurement light beams from a first interferometer and second interferometer do not strike the one of the first stage and the second stage, and to measure the positions of the first mirror and second mirror arranged on the other stage by the first interferometer and the second interferometer.

### BACKGROUND OF THE INVENTION

1. Field of the Invention

The present invention relates to a stage apparatus, an exposure apparatus, and a device fabrication method.

2. Description of the Related Art

The shapes of wafer stage top plates WS1 and WS2 in FIG. 1 determine the relative positional relationship between an exposure apparatus main body (represented by an interferometer bar mirror) and a wafer as a processing object. If an unexpected variation in this relationship occurs between these two objects, it translates into an overlay error of the reticle pattern projected onto the wafer, resulting in a decrease in the yield of products. Examples of the factors which vary the relative positional relationship between the wafer and the exposure apparatus main body are external forces applied to a wafer chuck upon its replacement and cleaning, and a temporal change in the properties of a member which fastens an interferometer reflecting mirror.

For example, if an X mirror MX deforms in a stage apparatus (FIG. 9) having a single stage, an interferometer which performs measurement along the X-axis generates an erroneous measurement value. An intersection LC between measurement light optical axes XD and YD of interferometers in the stage apparatus having a single stage coincides with the center of the image height of a projection lens UL. The distance between the intersection LC and a measurement center OAS of an off-axis alignment scope spaced apart from the optical axis of the projection lens UL is called the “base line length (BL)”.

An error due to deformation of the wafer stage top plate changes depending on a position y of the bar mirror in the Y direction, where measurement light from the interferometer enters, and the amount of error is given by ΔXd(xb(y)). That is, when measurement light from the interferometer enters the position y of the bar mirror (normally, xb(y)=−y) which performs measurement along the X-axis, the amount of error in the X direction due to deformation of the bar mirror changes depending on the mirror shape as the wafer stage moves in the Y direction. When the θ coordinate of the wafer stage is measured along the X-axis, a measurement error along the θ-axis is generated as a shift error in the X direction. The measurement error in the θ direction is negligible, if any, because a general off-axis alignment scope is one-eyed. The shift error in the X direction generated by the rotational component of the wafer stage is given by C×ΔXq(y)̂2.

An error ΔX generated due to deformation of the X mirror MX is given by:

ΔXd(xb(y))+C×ΔXq(xb(y))×BL_Y

where y is the Y-coordinate of the bar mirror assuming that a predetermined point of interest on the wafer is the center of the image height of the projection lens, ΔXd(y) and ΔXq(y) are the shift error and rotation error in the X direction between when the predetermined point of interest on the wafer is the center of the image height of the projection lens and when it is the measurement center of the off-axis alignment scope, C is a constant determined in accordance with design parameters such as the beam span of the interferometer which performs measurement along the θ-axis, and BL_Y is the base line length (the distance, in the Y direction, between the measurement center of the off-axis alignment scope and the intersection between the measurement light optical axes in the X and Y directions).

Although the above description assumes that the base line length in the X direction is zero for the sake of simplicity, an error in the Y direction is generated unless the base line length in the X direction is zero.

The stage apparatus (FIG. 9) having a single stage generates the above-described error between alignment measurement and exposure by an unobservable amount, resulting in deterioration in overlay accuracy.

To solve this problem, Japanese Patent Laid-Open No. 5-010748 proposes a method of monitoring a variation in the shape of the interferometer bar mirror due to a temporal change in the properties of the wafer stage top plate by periodical interferometer bar mirror shape correction or management based on the pattern printing result.

However, a system having a plurality of wafer stages as shown in FIG. 11 (a description of individual components is the same as that with reference to FIG. 1) is designed to irradiate the bar mirror with measurement light from the interferometer from the periphery of a stage stroke, in order to reduce the footprint of the stage apparatus. In this design, the measurement station and exposure station use different Y mirrors for interferometers. This makes it necessary to precisely manage, for example, the relative positions (at least one of the relative positions, relative orientations, and shape differences) between Y mirrors MYD1 and MYD2 used in the measurement station and Y mirrors MYU1 and MYU2 used in the exposure station.

Bar mirror shape correction utilizing the interferometer redundancy cannot measure a variation in a low-order component (orthogonality component) of the mirror shape. Pattern printing and measurement using a standard wafer to compensate for this drawback cannot take real-time measures when a variation in a low-order component of the mirror shape occurs, so they are unsuitable for confirmation for each lot input. In the example of the stage apparatus having a single stage described above, one mirror is used for measurement along each axis. Even when a variation in a low-order component of the mirror shape occurs, an alignment stage grid and exposure stage grid change in synchronism with each other. Since an alignment correction function for each wafer corrects the overall variation in a low-order component of the mirror shape, the overlay accuracy does not deteriorate practically.

When the measurement station and exposure station in a system having a plurality of wafer stages use different Y mirrors for interferometers, changes in the relative positions and the like between these mirrors are never corrected on the basis of the alignment measurement result. This makes uncorrected changes remain as overlay errors. Under the circumstance, it is demanded to detect, in a short period of time, changes in the relative positions between the Y mirrors for the interferometers due to, for example, deformation of each wafer stage top plate.

### SUMMARY OF THE INVENTION

The present invention provides a technique of detecting changes in, for example, the relative positions between a plurality of mirrors on one of a plurality of stages without degrading the productivity of an exposure apparatus.

According to one aspect of the present invention, there is provided a stage apparatus comprising a base, a first stage and second stage configured to move between a first area and second area on a stage moving surface of the base, a first mirror and second mirror arranged on the first stage and second stage, respectively, to measure positions of the stages in a first direction parallel to the stage moving surface, a first interferometer which is arranged in the first area on the base and configured to measure a position of the first mirror, a second interferometer which is arranged in the second area on the base and configured to measure a position of the second mirror, and a control unit configured to control to move one of the first stage and the second stage to a position where measurement light beams from the first interferometer and second interferometer do not strike the one of the first stage and the second stage, and to measure the positions of the first mirror and second mirror arranged on the other stage by the first interferometer and the second interferometer.

According to another aspect of the present invention, there is provided a stage apparatus comprising a base, a first stage and second stage configured to move between a first area and second area on a stage moving surface of the base, a first mirror and second mirror respectively arranged on the stages to measure positions of the stages in a first direction parallel to the stage moving surface, a first interferometer which is arranged in the first area on the base and configured to measure a position of the first mirror, a second interferometer which is arranged in the second area on the base and configured to measure a position of the second mirror, a calculation unit configured to calculate a correction value for at least one of a relative position, relative orientation, and relative shape between the first mirror and the second mirror based on the positions of the first mirror and the second mirror, which are measured by the first interferometer and the second interferometer, and a control unit configured to control one of the first stage and the second stage based on the correction value calculated by the calculation unit.

According to still another aspect of the present invention, there is provided a stage apparatus comprising a base, a first stage and second stage configured to be able to move between a first area and second area on a stage moving surface of the base, a first mirror and second mirror respectively arranged on the stages to measure positions of the stages in a first direction parallel to the stage moving surface, a first interferometer which is arranged in the first area on the base and configured to measure a position of the first mirror, a second interferometer which is arranged in the second area on the base and configured to measure a position of the second mirror, a calculation unit configured to calculate a correction value for at least one of a relative position, relative orientation, and relative shape between the first mirror and the second mirror based on the positions of the first mirror and the second mirror, which are measured by the first interferometer and the second interferometer, and a control unit configured to compare the value calculated by the calculation unit with a threshold value prepared in advance, and send a message indicating an abnormality if the calculated value exceeds the threshold value.

According to yet another aspect of the present invention, there is provided an exposure apparatus comprising an optical system configured to project a pattern of an original onto a substrate, and the above stage apparatus which is configured to hold and align one of the substrate and the original.

According to still yet another aspect of the present invention, there is provided a device fabrication method comprising steps of exposing a substrate using the above exposure apparatus, and performing a development process for the substrate exposed.

Further features of the present invention will become apparent from the following description of exemplary embodiments with reference to the attached drawings.

### BRIEF DESCRIPTION OF THE DRAWINGS

FIG. 1 is a schematic view showing a wafer stage unit of a stage apparatus according to a preferred embodiment of the present invention.

FIG. 2 is a view showing an exposure apparatus according to the preferred embodiment of the present invention.

FIG. 3 is a view showing a state in which a top plate has deformed or a mirror has been shifted in a wafer stage.

FIG. 4 is a sectional view taken along a line Q-Q′ of the wafer stage shown in FIG. 3.

FIG. 5 is a flowchart illustrating s stage distortion confirmation sequence.

FIG. 6 is a flowchart illustrating an intermediate step of a lot processing sequence according to the preferred embodiment of the present invention.

FIG. 7 is a flowchart illustrating a processing sequence when an allowable value error is generated in the stage distortion confirmation sequence.

FIG. 8 is a flow diagram illustrating interferometer measurement value processing.

FIG. 9 is a schematic view showing a wafer stage unit of a conventional exposure apparatus having a single stage.

FIG. 10 is a graph showing an example of a YUYD relative variation table and the correction amount calculated based on this table.

FIG. 11 is a schematic view showing a wafer stage unit of an exposure apparatus to which the preferred embodiment of the present invention is not applied.

FIG. 12 is a graph showing the result of a plurality of number of times of measurement by an interferometer while an exposure apparatus to which the preferred embodiment of the present invention is applied scans it in the X direction.

### DESCRIPTION OF THE EMBODIMENT

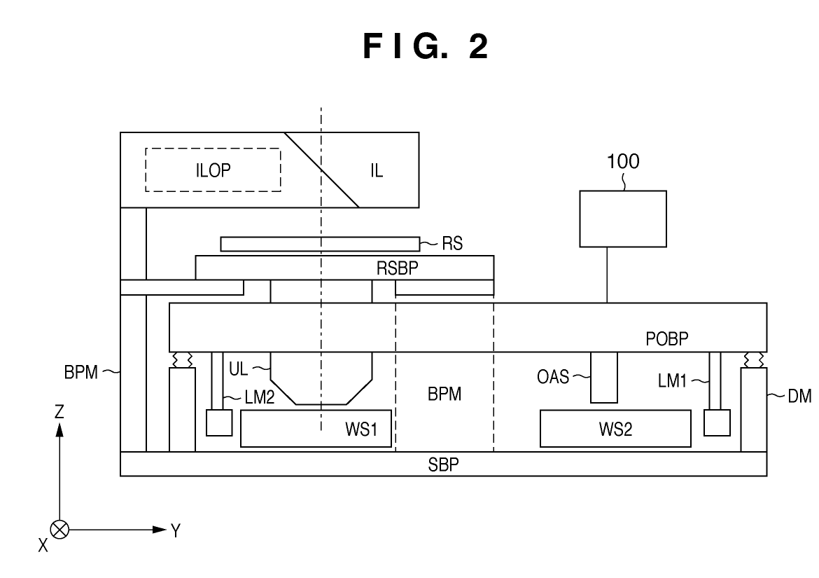

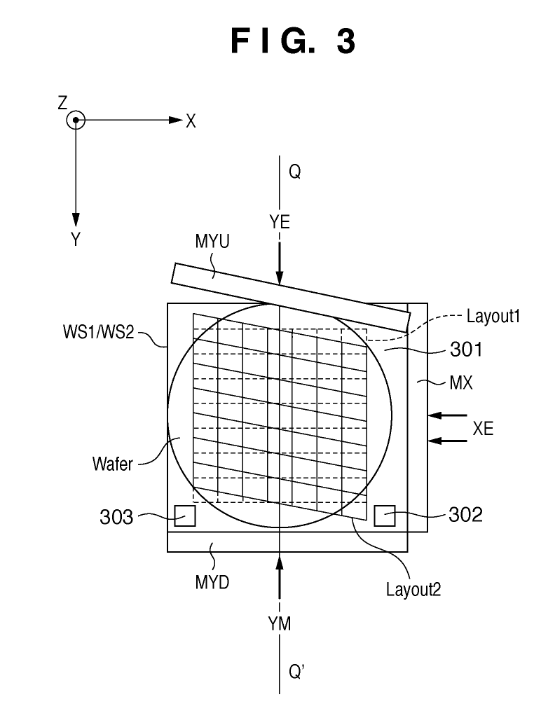

FIG. 2 is a view showing an exposure apparatus according to a preferred embodiment of the present invention. An illumination unit IL includes optical members ILOP such as a masking blade (not shown) and relay lens which are driven in synchronism with the scanning of a reticle stage RS, and is supported by a support body BPM and a base plate SBP installed on the floor surface. A base plate RSBP supports the reticle load and a reticle driving reaction force, and is supported by the base plate SBP while being insulated against vibration from a lens barrel support body POBP. The lens barrel support body POBP mounts a projection lens UL serving as an optical system and interferometers LM1 and LM2. The lens barrel support body POBP is kept to float from the base plate SBP by dampers DM. Any disturbance from the floor is thus damped before reaching the lens barrel support body POBP. An off-axis alignment scope OAS is a two-dimensional alignment mark measuring mechanism having a focus measurement function. A control unit 100 controls constituent units of the exposure apparatus. The off-axis alignment scope OAS measures the relative positional and orientational relationships between alignment marks on wafers held by a wafer stage (first stage) WS1 and wafer stage (second stage) WS2 and wafer stage reference marks (not shown). With this operation, the wafer stages WS1 and WS2 are driven to design coordinates. Measurement along the Z direction and leveling direction is also performed at this time, but a description thereof will not be given as it departs from the spirit and scope of the present invention. The wafer stage WS1 having undergone the wafer measurement is passed to the exposure station (under the projection lens UL) upon being swapped with the wafer stage WS2 in the exposure station. The wafer stage WS1 passed to the exposure station is aligned by exchanging exposure light between an on-axis alignment mark formed on the reticle and an alignment sensor (not shown) on the wafer stage WS1. The alignment sensor on the wafer stage WS1 and the wafer stage reference mark are integrated as each of sensor units 302 and 303 in FIG. 3. A plurality of (two in the example shown in FIG. 3) sensor units are fixed on the wafer stage top plate. Since a wafer chuck which holds the wafer is fixed on the wafer stage top plate, the wafer, the alignment sensor on the wafer stage WS1, and the wafer stage reference mark always hold a fixed positional relationship. The reticle is therefore aligned by exchanging exposure light between the alignment sensors (not shown) on the wafer stage WS1. This makes it possible to align the reticle relative to the shot layout on the wafer in the X and Y directions via the wafer stage reference marks and the alignment sensors on the wafer stage WS1. The pattern of the reticle is projected onto the wafer held by the wafer stage WS1, in accordance with an exposure order and layout defined in a recipe in advance. Alignment errors may occur between the pattern of the reticle and the pattern transferred onto the wafer due to the following factors:

Reticle: [1] Pattern formation error; [2] Reticle deformation; [3] Reticle chucking error

Reticle alignment mark: [4] Stage alignment measurement error; [5] Variation in aberration of projection lens

Alignment sensor on wafer stage: [6] Difference between illumination modes; [7] Deformation of top plate

Wafer stage reference mark: [8] Deformation of top plate; [9] Wafer alignment error; [10] Deformation of wafer

Wafer alignment mark: [11] Shot deformation error

The above description assumes that the wafer, the alignment sensor on the wafer stage, and the wafer stage reference mark hold a fixed positional relationship. However, the top plate slightly deforms over medium to long terms depending on the positional relationship among these three objects. A slight variation in the properties of a member attached on the wafer stage top plate is determined as the error factor of “[7] Deformation of top plate”, and directly influences an alignment error and focus error. The present invention aims at implementing an exposure apparatus performance assurance and self-correction function by measuring the error factor represented by “[7] Deformation of top plate” using a unit which measures the relative position between interferometer mirrors.

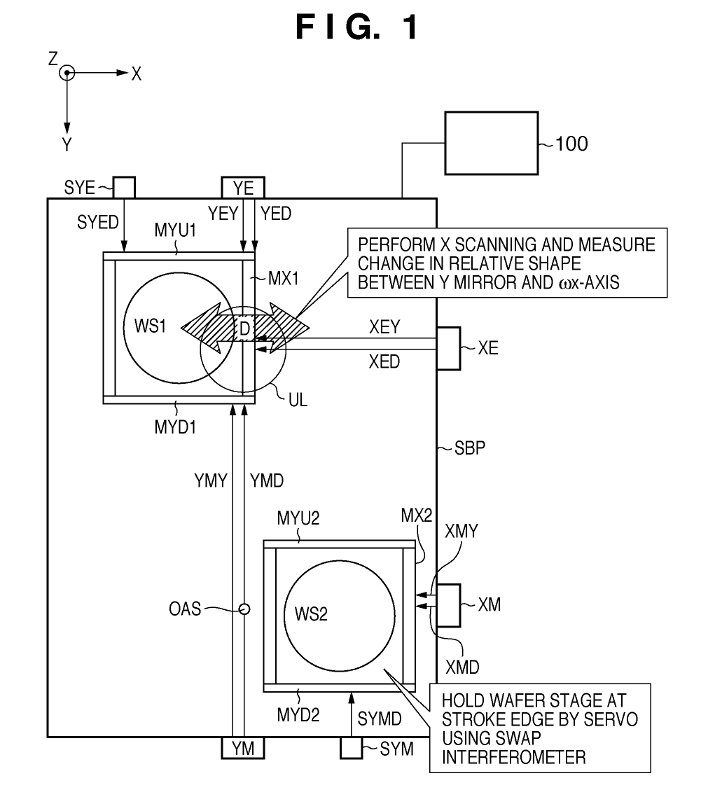

FIG. 1 is a schematic view showing a stage apparatus according to the preferred embodiment of the present invention. Referring to FIG. 1, the vertical direction is the Y-axis direction serving as a first direction parallel to the stage moving surface of the base plate SBP. The horizontal direction is the X-axis direction serving as a second direction which is parallel to the stage moving surface of the base plate SBP and perpendicular to the first direction. The upper half of FIG. 1 is an exposure station which includes the projection lens UL and serves as a first area on the stage moving surface of the base plate SBP. The lower half of FIG. 1 is a measurement station which includes the off-axis alignment scope OAS and serves as a second area on the stage moving surface of the base plate SBP. The plurality of wafer stages WS1 and WS2 can move on the stage moving surface of the base plate SBP in the two-dimensional directions (X and Y directions) with a long stroke. Each wafer stage includes a driving mechanism which can finely drive it in the ωx, ωy, and ωz directions in addition to the Z direction perpendicular to the base plate SBP and has a total of six driving axes. To implement such a mechanism, there is a method of, for example, forming an X-Y coarse moving stage by a plane pulse motor and mounting a six-axis fine moving stage on it. The stage movable ranges in the respective stations are independent of each other so as to avoid interference between these stages in driving sequences other than a stage swap. For wafer stage alignment, the exposure station (first area) uses measurement light beams XEY, XED, YEY, and YED emitted by interferometers XE and YE. The measurement station (second area) uses measurement light beams XMD, XMY, YMY, and YMD emitted by interferometers XM and YM. Swap interferometers SYM and SYE are used for a stage swap. When scheduled sequences have been executed for both the wafer stages WS1 and WS2 in the respective stations, the wafer stages WS1 and WS2 are swapped between the exposure station and the measurement station. At this time, the first interferometer YE and second interferometer YM cannot be used due to geometric design, so the swap interferometers SYM and SYE are prepared in order to perform measurement along the Y-axis alone.

Each wafer stage mounts interferometer mirrors via its top plate. A first mirror MYU1 of the wafer stage WS1 is used for measurement using the first interferometer YE and swap interferometer SYE in the exposure station. A second mirror MYD1 is used for measurement using the second interferometer YM and swap interferometer SYM in the measurement station. A mirror MX1 is used for measurement using the interferometer XM in the measurement station and measurement using the interferometer XE in the exposure station. A first mirror MYU2 of the wafer stage WS2 is used for measurement using the first interferometer YE and swap interferometer SYE in the exposure station. A second mirror MYD2 is used for measurement using the second interferometer YM and swap interferometer SYM in the measurement station. A mirror MX2 is used for measurement using the interferometer XM in the measurement station and measurement using the interferometer XE in the exposure station.

It is also possible to perform measurement along the Y-axis using one Y-axis interferometer mirror without setting Y-axis interferometer mirrors at the upper and lower edges in FIG. 1 of each wafer stage. However, this scheme requires that the measurement light from the Y-axis interferometer strike the mirror always from one side, so the apparatus size may increase.

When the wafer stage top plate deforms, measurement errors of the respective positions of members, that is, the interferometer mirrors, wafer chuck, reference marks, and stage alignment sensors are generated. Particularly the position measurement error of the interferometer mirror often accounts for medium- to long-term variations, including the attachment of the mirror itself. In this embodiment, a method of performance assurance and correction by measurement especially associated with, for example, the relative positions (including at least one of the relative positions, relative orientations, and shape differences) between the first mirror MYU1, second mirror MYD1, first mirror MYU2, and second mirror MYD2 which are symmetrical about the Y direction will be explained.

FIG. 3 is a view showing a state in which the top plate has deformed or mirror has been shifted in the wafer stage WS1 or WS2, and the relative position between the mirrors MYU and MYD has changed. The shot layout on the wafer measured in the measurement station is Layout1. However, the actually transferred shot layout is Layout2 because the mirror MYU is tilted with respect to an expected orientation. The use of the same mirrors between the measurement station and the exposure station (as in X-axis mirrors) allows obtaining alignment measurement values including the mirror orientation variation amount measured in the measurement station. The variation amount is thus corrected. However, an apparatus having a structure which uses different interferometer mirrors between alignment measurement and exposure processing needs to always take measures so that the variation factor shown herein falls within the allowable range.

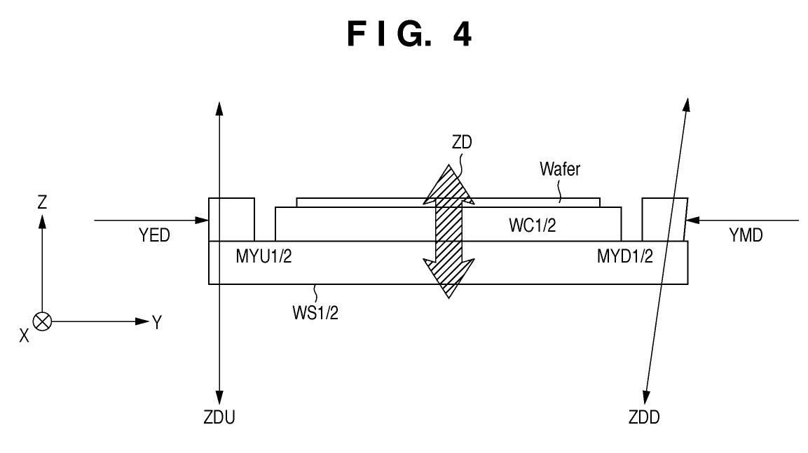

FIG. 4 is a sectional view taken along a line Q-Q′ of the wafer stage explained with reference to FIG. 3. FIG. 4 exaggerates a case in which the tilt ωx of the mirror MYD in the Z direction is not parallel to the mirror MYU. If the amount of tilt deviates from the design value or changes over medium to long terms, the following troubles occur. That is, if the wafer thickness nonuniformity largely varies (by about 100 microns), the positions, in the Z direction, of spots where the measurement light beams YED and YMD from the interferometers YE and YM strike the mirrors MYU and MYD vary, resulting in a shift error in the Y direction. Particularly when the driving target value of the wafer stage differs between the off-axis alignment scope OAS and the reticle imaging plane in water exposure, the shift error readily translates into an overlay error. Likewise, when the driving target value of the wafer stage differs between stage alignment and the reticle imaging plane in wafer exposure, an alignment error is generated. According to the preferred embodiment of the present invention, as shown in FIG. 1, moving the wafer stage WS1 not in the X direction but in the Z direction makes it possible to obtain a relative tilt angle wy between the mirrors MYU and MYD. The control unit 100 can correct the relative tilt angle ωy between the mirrors MYU and MYD to practically zero by adding, to the target value, the relative tilt angle ωy between the mirrors MYU and MYD calculated herein as a correction value for the error in the Y direction in driving about the Z-axis. In this embodiment, since a stroke consumed in the Z direction due to wafer thickness nonuniformity is about 100 microns, a correction unit which uses not a correction table as in the X-axis but a first-order function coefficient is adopted. However, the same method as that for the X-axis may be used when the used stroke is relatively large.

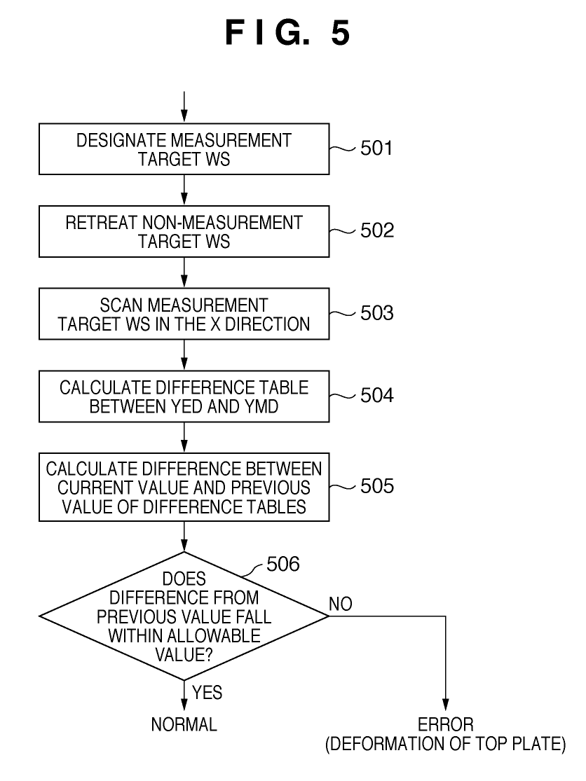

FIG. 5 is a flowchart illustrating a sequence of wafer stage top plate deformation measurement (to be referred to as “stage distortion confirmation” hereinafter) in the exposure apparatus according to the preferred embodiment of the present invention. In this sequence, the control unit 100 controls constituent units of the exposure apparatus. The stage distortion confirmation needs to be executed individually for a plurality of wafer stages of the exposure apparatus. In step 501, the wafer stage WS1 or WS2 is designated as the measurement target for which the stage distortion confirmation is to be executed. The stage distortion confirmation timing can be set for each stage in, for example, the intervals between production lots, and the plurality of wafer stages need not always be confirmed in a single stage distortion confirmation sequence. The wafer stage as the measurement target for which the stage distortion confirmation is to be executed may or may not hold a wafer on the wafer chuck. In step 502, a wafer stage which is not the measurement target for which the stage distortion confirmation is to be executed is retreated. This retreat is done by driving the non-measurement target to the position of the wafer stage WS2 in FIG. 1. That is, when the stage distortion confirmation sequence is executed for the wafer stage WS1 in the exposure station, the wafer stage WS2 is retreated to a position where the measurement light beams YMY and YMD from the second interferometer YM do not strike the wafer stage WS2. A preferable example of the position is the start position of swap driving of the wafer stage WS2. The position of the wafer stage WS2 along the Y-axis is obtained by simultaneously using a positional servo and a measurement light beam SYMD from the swap interferometer SYM. The wafer stage WS2 may or may not hold the wafer on the wafer chuck. At this position, the second mirror MYD2 of the wafer stage WS2 does not reflect the measurement light beams YMD and YMY of the second interferometer YM.

In step 503, the wafer stage WS1 as the measurement target for which the stage distortion confirmation sequence is to be executed is scanned in the X direction by fixing the target values in the Y and θ directions. This driving can also serve as the stage distortion confirmation sequence (652 and 653 and 655 and 656) in a step of driving the wafer stage WS1 between the stage alignment sensors 302 and 303 in a stage alignment sequence. This is preferable also from the viewpoint of an improvement in the productivity of the exposure apparatus. In this case, the wafer stage swapped to the measurement station needs to retreat to a position where it does not shield the measurement light from the second interferometer YM in the measurement station until the step of driving the wafer stage between the stage alignment sensors 302 and 303 ends. The control (servo) of the wafer stage WS1 is performed based on the position measurement results obtained by the first interferometer YE and interferometer XE. There is no special preference as to the Y-coordinate of the wafer stage WS1 as long as the measurement light beams YMY and YMD from the second interferometer YM are adjusted ideally. However, to avoid a decrease in the alignment accuracies along the optical axes of the measurement light beams YMY and YMD, the Y-coordinate of the wafer stage WS1 for which the stage distortion measurement is to be executed is preferably as close to the second interferometer YM as possible so that a wide span is ensured. For example, the wafer stage is desirably positioned at the boundary (in general, the center position of the plate in the Y direction) between the exposure station and the measurement station. For the same reason, target values at which the plane of the second mirror MYD1 becomes perpendicular to the optical axes of the measurement light beams YMY and YMD need to be selected for the θ- and leveling-axes.

In step 504, a sequence of calculating the measurement difference between the measurement light beams YMD and YED is executed. In this embodiment, the first interferometer YE performs control along the Y-axis, and the second interferometer YM is set in a measurement mode alone and scanned in the X direction. The second interferometer YM is scanned in the X direction and the measurement values obtained by the second interferometer YM and first interferometer YE are acquired at the sample clock timing. The measurement value obtained by the second interferometer YM desirably remains the same during the scanning in the X direction. In practice, however, this value normally does not stay constant because of, for example, a temporal change in the properties of the top plate and the fact that the first mirror MYU1 is not perfectly parallel to the second mirror MYD1.

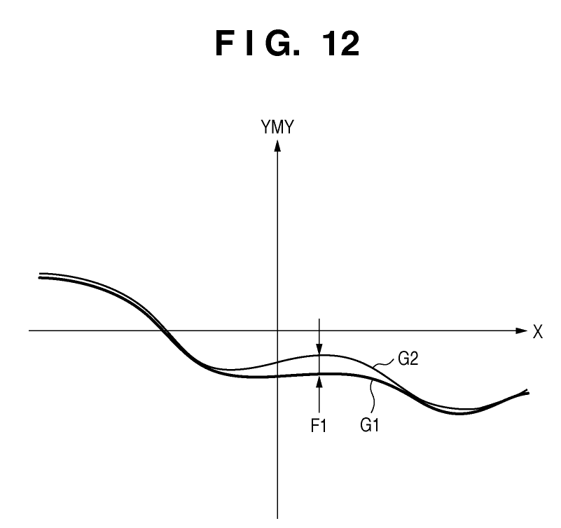

FIG. 12 shows this example. FIG. 12 is a graph showing the result of a plurality of number of times of measurement for the measurement light beam YMY by scanning the second interferometer YM in the X direction. Reference symbol G1 indicates the measurement value profile along the optical axis of the measurement light beam YMY, which is measured in early stages of the assembly and adjustment of the exposure apparatus; and G2, the measurement value profile along the optical axis of the measurement light beam YMY, which is measured during subsequent apparatus operation. The profile G1 does not take zero because an error is generated upon individually adjusting the wafer stages WS1 and WS2. Although this error is not attributed to stage deformation, it may be corrected by feeding it back to the mirror shape, aberration correction, and orthogonality correction coefficient in order to match stage grids between the measurement station and the exposure station. A variation in wafer stage distortion is expressed by the difference between the measurement value profiles measured in early stage of adjustment and during apparatus operation, that is, G2-G1(=F1). The variation component G2-G1 contains the amount of variation due to servo errors and air fluctuation, in addition to deformation of the wafer stages and interferometer reflecting mirrors. To reduce these error factors, preferably, the measurement value profiles obtained by a plurality of number of times of scanning are averaged, or those obtained by scanning at different speeds are averaged, in addition to LPF processing of the waveforms themselves.

It is the main object of the present invention to effectively assuring the alignment performance of the exposure apparatus by measuring the variation component and adding it to a mirror shape correction table and correcting it, or determining its threshold value and detecting an abnormality. The processing operation referred to as “Calculate difference between current value and previous value of difference tables” in step 505 means extracting the variation component. That is, YUYD difference tables for the first mirror MYU1, second mirror MYD1, first mirror MYU2, and second mirror MYD2 upon apparatus adjustment by a periodical check such as printing result collation are extracted. The variation component from this table is calculated from the value measured in the stage distortion confirmation sequence. That is, the difference between the YUYD difference table upon a check and that obtained in the stage distortion confirmation sequence is calculated. A table containing the relative amount of deformation of the YUYD mirror which has varied from the state described in the YUYD difference table upon a check will be referred to as a “YUYD relative variation table” hereinafter. In step 506, it is determined whether the absolute amount of the YUYD relative variation table, that is, the relative amount of deformation of the mirror which has varied from the state upon a periodical check falls within the allowable value, thereby detecting an error. If YES in step 506, it is determined that the apparatus status is “normal”, and a subsequent job is executed directly. If NO in step 506, it is determined that an error has been generated due to deformation of the top plate. If an error has been generated, the apparatus operation is stopped for a maintenance check. However, the apparatus can be automatically restored by self calibration without being stopped due to an error in the following case. That is, this applies to a case in which the YUYD relative variation table falls outside the allowable value due to a variation whose cause is clearly identified, and software can perform feedback correction of the amount of deformation described in the YUYD relative variation table.

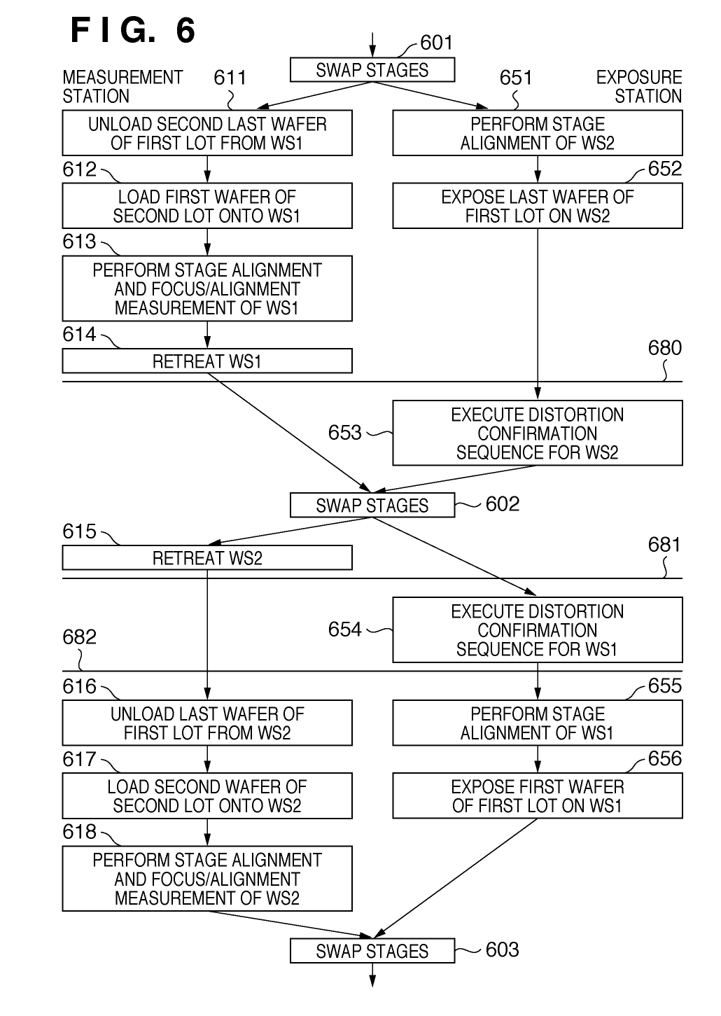

FIG. 6 is a flowchart illustrating an intermediate step of a lot processing sequence according to the preferred embodiment of the present invention. In this flowchart, the control unit 100 controls constituent units of the exposure apparatus. The right side indicates the sequence in the exposure station, while the left side indicates the sequence in the measurement station. In the interval between stage swap sequences in steps 601 and 602, the stage distortion measurement is performed immediately before a swap. In the interval between stage swap sequences in steps 602 and 603, the stage distortion measurement is performed immediately after a swap. These operations can be simultaneously performed and selected depending upon each application. For example, if the stage distortion measurement is performed for each lot processing or lot processing is continuous, a sequence of performing the stage distortion measurement at a time immediately before a swap, at which the apparatus is free from any processing overhead, is inserted once for each stage in lot switching. In this case, the stage distortion measurement inserted between the lots guarantees that normal processing is performed for a previous lot and also confirms that there is no problem with inputting the next lot. If lot processing is interrupted, the latter confirmation may fail. To avoid this situation, it is necessary to insert, immediately before lot processing, a sequence of performing the stage distortion measurement immediately after a swap.

In step 601, a stage swap sequence of swapping the wafer stage WS1 in the exposure station and the wafer stage WS2 in the measurement station is executed. At the start of the flowchart according to this embodiment, that is, before step 601, the wafer stages WS1 and WS2 hold wafers of the first lot. After a stage swap, the wafer stage WS1 holds the second last wafer of the first lot, while the wafer stage WS2 holds the last wafer of the first lot.

In step 611, the second last wafer of the first lot is unloaded. Instead, the first wafer of the second lot is loaded onto the wafer stage WS1 (step 612). To detect the relative positions between the off-axis alignment scope OAS and a plurality of stage reference marks (not shown), the wafer stage WS1 is aligned in the measurement station. Next, wafer focus map measurement and alignment measurement are performed using the position of the off-axis alignment scope OAS as a reference (step 613). In step 614, a sequence of retreating the wafer stage WS1 to a position where it does not shield the second interferometer YM to execute a stage distortion confirmation sequence (step 653) for the wafer stage WS2 in the exposure station is executed. In general, the focus map measurement and alignment measurement in the measurement station end earlier than the exposure processing. From the viewpoint of an improvement in apparatus productivity, wafer stage retreat is executed in the measurement station, while distortion measurement is executed in the exposure station in this embodiment. If the processing time in the measurement station exceeds that in the exposure station because the number of alignment sample shots is excessively increased, the stage distortion measurement is performed in the measurement station. The wafer stage in the exposure station is then retreated. This embodiment can also be practiced and falls within the application range of the present invention.

The reticle alignment marks and the position sensors on the wafer stage top plate align, in the X, Y, θ, and Zωy directions, the reticle and the origin of the wafer stage WS2 swapped in the exposure station (step 651). The relative positional relationship between the wafer onto which the reticle pattern is to be transferred and the reference mark fixed on the wafer stage top plate in the measurement station is measured. Both the position sensors and stage reference marks are fixed on the wafer stage top plate. The reticle alignment marks and wafer therefore can reproduce an accurate positional relationship via the stage reference marks and the position sensors on the top plate. In step 652, a sequence of exposing the last wafer of the first lot is executed. Based on the wafer focus alignment information measured in the measurement station, the reticle pattern is sequentially transferred onto the wafer while scan-driving the wafer stage. In step 653, the stage distortion confirmation sequence as a feature of the present invention is executed by confirming that the wafer stage WS1 in the measurement station has been driven to the retreat position. Details of the stage distortion confirmation sequence are as explained with reference to FIG. 5. When the stage distortion confirmation sequence is complete, the stages are swapped (step 602). Segments 680, 681, and 682 correspond to the above-described processing of “confirming that the wafer stage WS1 has been driven to the retreat position” and mean that the upper and lower processing operations segmented by the segments are temporally isolated.

The above description has exemplified a sequence of executing the stage distortion confirmation sequence immediately before a stage swap. The following description will exemplify a sequence of executing the distortion confirmation sequence immediately after a stage swap.

The swapped wafer stage WS2 moves to the measurement station, and stands by at a position where it does not shield the second interferometer YM while being controlled in the Y direction by the swap interferometer (step 615). After this standby state is confirmed, the stage distortion confirmation sequence is executed for the wafer stage WS1 in the exposure station (step 654). During the execution of step 654, subsequent processing in the measurement station is blocked to exclusively use the second interferometer YM. After the stage distortion confirmation sequence (step 654) in the exposure station is completed, individual processing operations can be executed in the respective stations. The last wafer of the first lot is unloaded from the wafer stage WS2 in the measurement station (step 616). The second wafer of the second lot is loaded onto the wafer stage WS2 (step 617). The same stage alignment, focus map measurement, and alignment measurement as in step 613 are performed (step 618).

In the exposure station after the stage distortion confirmation sequence is completed, wafer stage alignment with exposure light is performed in the same way as in steps 651 and 652. Based on the wafer focus alignment information measured in the measurement station, the reticle pattern is sequentially transferred onto the wafer by exposure while scan-driving the wafer stage. After both the processing operations in steps 618 and 656 are completed, the wafer stages are swapped (step 603).

Although the stage distortion confirmation sequence does not require removing the wafer held by the wafer stage, the productivity slightly degrades by the time taken to scan the measurement target wafer stage. To avoid this situation, it is necessary to appropriately control the execution timing to be able to detect deformation of the wafer stage top plate free from any deterioration in overlay accuracy. For example, this control may be implemented by a mode (command execution from an online host) which is not incorporated in the lot processing sequence in weekly maintenance of the exposure apparatus. If slight degradation is tolerable, the stage distortion confirmation sequence may be executed for each wafer. However, in practice, to detect deterioration in overlay accuracy due to deformation of the top plate before final device inspection, the confirmation measurement is performed the moment that the last wafer of a lot is processed. If an abnormality is found in the confirmation measurement, reworking the lot makes it possible to minimize the trouble of taking measures necessary for a lot with a failure. The stage distortion confirmation sequence needs to be executed for the two wafer stages.

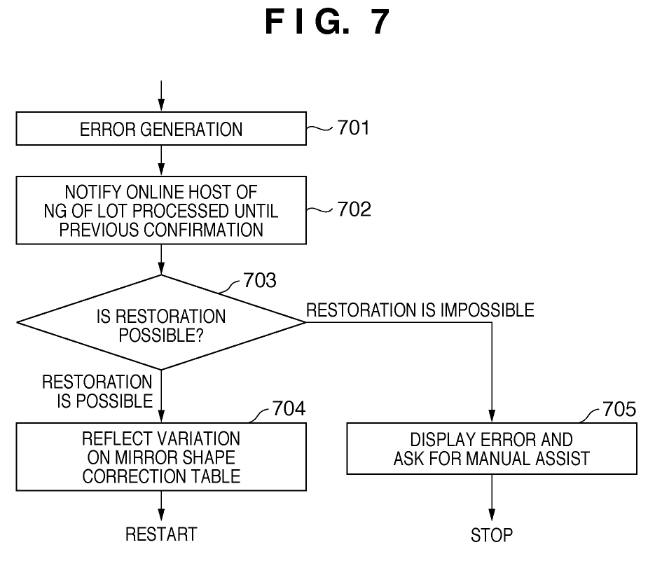

FIG. 7 is a flowchart illustrating processing when an allowable value error is generated in the stage distortion confirmation sequence shown in FIG. 5. In this processing, the control unit 100 controls constituent units of the exposure apparatus. If an allowable error is generated in step 701, an online host is notified that a lot processed in the period from the previous stage distortion confirmation sequence until now suffers a failure (step 702). It is determined whether the amount of variation of the relative deformation amount table of the YUYD mirror can be restored by feedback correction of, for example, the mirror shape correction table (step 703). If the restoration is possible, the mirror shape correction table, aberration correction parameter, orthogonality correction parameter, and the like are corrected (step 704), and subsequent lot processing service is restarted. If the amount of variation is too large to restore, service is stopped by, for example, displaying an error or notifying the online host of the error, and the apparatus enters a manual assist standby state (step 705).

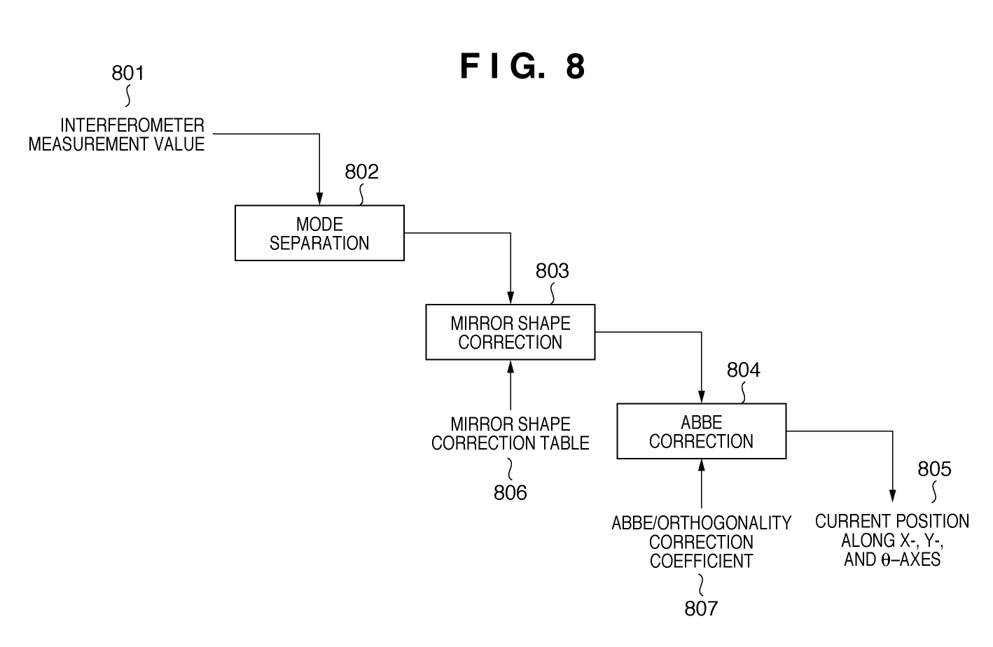

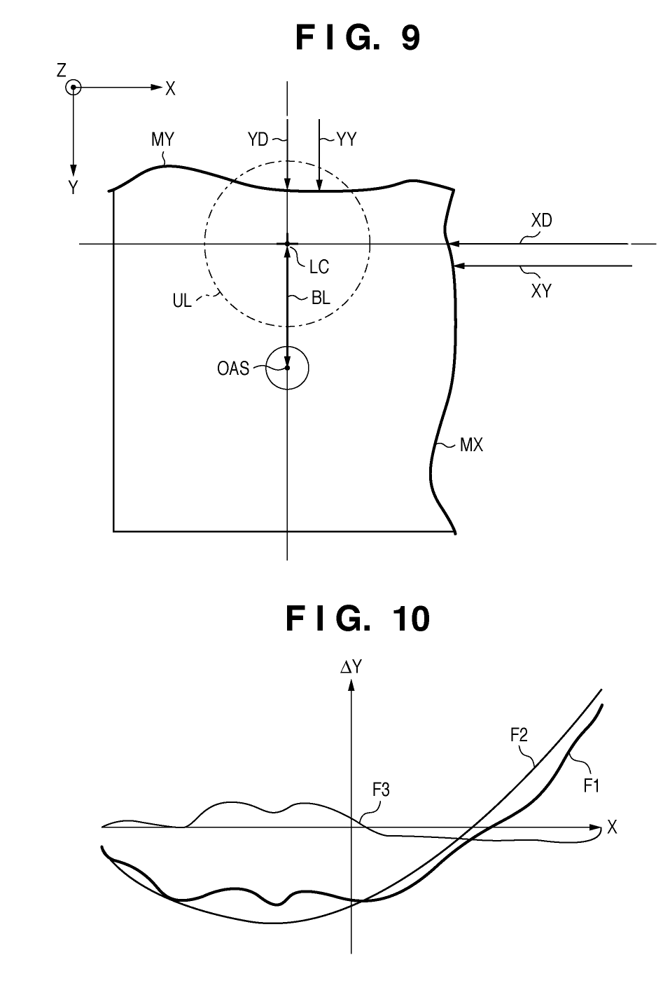

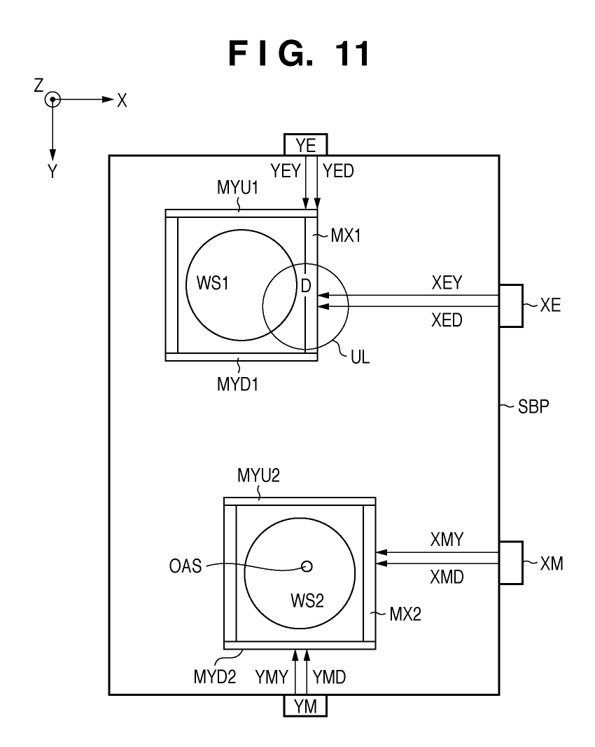

FIG. 8 is a flow diagram illustrating interferometer measurement value processing applied to the prior arts and the embodiment of the present invention. In this processing flow diagram, the control unit 100 controls constituent units of the exposure apparatus. Since a position signal (measurement value) 801 obtained by each of, for example, the interferometers YM, YE, XM, and XE shown in FIG. 1 cannot be represented by an orthogonal system such as an abstract coordinate system, it is converted by mode separation processing 802. That is, this processing gives a value obtained by dividing the difference between the measurement light beams XMD and XMY by the beam span to the current position of the wafer stage along the θ-axis in the measurement station. Mirror shape correction processing 803 of correcting an amount by which the interferometer reflecting mirror is not perfectly flat is performed. In this embodiment, the mirror shape correction table is obtained by generating a second-order function approximation profile for the difference from an original flat shape. The differences (three- and higher-order function components) from the profile are held as the mirror shape correction table. Second- and lower-order function components as correction components are corrected by Abbe correction 804 subsequent to the processing 803. Holding second- and lower-order function components as correction components in the mirror shape correction table is redundant from the viewpoint of design but is not disadvantageous to the correction system. It is also possible to directly add the calculated value of the relative deformation amount table of the YUYD mirror to the mirror shape correction table. The Abbe correction 804 serves to functionally correct lower-order error components generated when the optical axis of the interferometer measurement light beam is inclined or the interferometer mirror is tilted with respect to the design value. These processing operations allow obtaining a current position 805 of the wafer stage along the X-, Y-, and θ-axes.

FIG. 10 is a graph showing an example of the YUYD relative variation table explained with reference to FIG. 5, and the amount of correction calculated based on this table. Reference symbol F1 indicates the measured raw waveform of the YUYD relative variation table; F2, the second-order function approximation profile; and F3, a difference (YUYD high-order correction amount) obtained by subtracting the second-order function approximation profile F2 from the raw waveform F1. The first-order component of the second-order function approximation profile F2 is fed back to Abbe/orthogonality correction 807 shown in FIG. 8, while the second-order component is fed back to the amount of correction, by which the θ-axis is corrected in proportion to X driving, of the Abbe/orthogonality correction 807 shown in FIG. 8. The YUYD high-order correction amount F3 is fed back to a mirror shape correction table 806 shown in FIG. 8. From the viewpoint of hardware maintenance and management, it is convenient to display the graph as shown in FIG. 10 on the user interface of the exposure apparatus or to send this data to an online host.

The above description has exemplified a mechanism and method which measure the relative relationship between two reflecting mirrors on a wafer stage in a system which uses different interferometer reflecting mirrors between the exposure station and the measurement station. To maintain the same stage coordinate grid between the exposure station and the measurement station, it is necessary to match the positions and shapes of mirrors which cannot be commonly used between the exposure station and the measurement station. The present invention provides a method of accurately, directly performing the matching using an interferometer system without individual stage unit adjustment or exposure result accumulation. This method basically allows performing measurement by a wafer stage measuring system in one station during the adjustment of a wafer stage in the other station, and calculates the difference between two measuring systems. In the calibration application of the exposure apparatus, the use of all of a mechanism which performs measurement by a wafer stage measuring system in one station during the adjustment of a wafer stage in the other station, the sequence of this system, and an optimization procedure during the lot processing sequence falls within the application range of the present invention.

A method of fabricating a semiconductor device using an exposure apparatus according to a preferred embodiment of the present invention will be explained next. Devices are manufactured by a step of exposing a substrate (e.g., a wafer or glass plate) coated with a resist (photosensitive agent) using the above-described exposure apparatus, a step of developing the exposed substrate, and other known steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-154434 filed on Jun. 11, 2007, which is hereby incorporated by reference herein in its entirety.

What is claimed is:

1. A stage apparatus comprising:
a base;
a first stage and second stage configured to move between a first area and second area on a stage moving surface of the base;
a first mirror and second mirror arranged on the first stage and second stage, respectively, to measure positions of the stages in a first direction parallel to the stage moving surface;
a first interferometer which is arranged in the first area on the base and configured to measure a position of the first mirror;
a second interferometer which is arranged in the second area on the base and configured to measure a position of the second mirror; and
a control unit configured to control to move one of the first stage and the second stage to a position where measurement light beams from the first interferometer and second interferometer do not strike the one of the first stage and the second stage, and to measure the positions of the first mirror and second mirror arranged on the other stage by the first interferometer and the second interferometer.

2. The apparatus according to claim 1, further comprising a unit configured to calculate a correction value for at least one of a relative position, relative orientation, and shape difference between the first mirror and the second mirror based on the positions of the first mirror and the second mirror, which are measured by the first interferometer and the second interferometer.

3. The apparatus according to claim 1, wherein the control unit performs the measurement by the first interferometer and the second interferometer while moving one of the first stage and the second stage in a second direction which is parallel to the stage moving surface and perpendicular to the first direction.

4. The apparatus according to claim 1, wherein the control unit performs the measurement by the first interferometer and the second interferometer while moving one of the first stage and the second stage in a direction perpendicular to the stage moving surface.

5. The apparatus according to claim 1, wherein the control unit performs the measurement by the first interferometer and the second interferometer immediately before or immediately after the first stage and the second stage swap upon moving between the first area and the second area.

6. The apparatus according to claim 1, wherein the control unit performs the measurement by the first interferometer and the second interferometer when one of the first stage and the second stage is positioned at a boundary between the first area and the second area.

7. The apparatus according to claim 1, wherein the control unit detects an error based on the measurement results obtained by the first interferometer and the second interferometer and measurement results obtained in advance.

8. The apparatus according to claim 1, wherein the control unit performs the measurement by the first interferometer and the second interferometer immediately before or immediately after a lot.

9. The apparatus according to claim 1, wherein
one of the first area and the second area lies in an exposure station, while the other one lies in a measurement station, and
the control unit moves one of the first stage and the second stage positioned in the measurement station to a position where measurement light beams from the first interferometer and the second interferometer do not strike the one of the first stage and the second stage.

10. An exposure apparatus comprising:
an optical system configured to project a pattern of an original onto a substrate; and
a stage apparatus according to claim 1, which is configured to hold and align one of the substrate and the original.

11. A device fabrication method comprising steps of:
exposing a substrate using an exposure apparatus according to claim 10; and
performing a development process for the substrate exposed.

12. A stage apparatus comprising:
a base;
a first stage and second stage configured to move between a first area and second area on a stage moving surface of the base;
a first mirror and second mirror respectively arranged on the stages to measure positions of the stages in a first direction parallel to the stage moving surface;
a first interferometer which is arranged in the first area on the base and configured to measure a position of the first mirror;
a second interferometer which is arranged in the second area on the base and configured to measure a position of the second mirror;
a calculation unit configured to calculate a correction value for at least one of a relative position, relative orientation, and relative shape between the first mirror and the second mirror based on the positions of the first mirror and the second mirror, which are measured by the first interferometer and the second interferometer; and
a control unit configured to control one of the first stage and the second stage based on the correction value calculated by the calculation unit.

13. A stage apparatus comprising:
a base;
a first stage and second stage configured to be able to move between a first area and second area on a stage moving surface of the base;
a first mirror and second mirror respectively arranged on the stages to measure positions of the stages in a first direction parallel to the stage moving surface;
a first interferometer which is arranged in the first area on the base and configured to measure a position of the first mirror;
a second interferometer which is arranged in the second area on the base and configured to measure a position of the second mirror;
a calculation unit configured to calculate a correction value for at least one of a relative position, relative orientation, and relative shape between the first mirror and the second mirror based on the positions of the first mirror and the second mirror, which are measured by the first interferometer and the second interferometer; and
a control unit configured to compare the value calculated by the calculation unit with a threshold value prepared in advance, and send a message indicating an abnormality if the calculated value exceeds the threshold value.
